(19) United States
(12) Patent Application Publication
(10) Pub. No.: US 2004/0108009 A1
(43) Pub. Date: Jun. 10, 2004

(54) Method of repairing flow passage

(75) Inventors: Takao Kamiyama, Hiratsuka-shi (JP); Yasuhiro Yokoshima, Yuki-gun (JP)

Correspondence Address: CHAPMAN AND CUTLER, 111 WEST MONROE STREET, CHICAGO, IL, 60603, US

(73) Assignees: SHONAN GOSEI-JUSHI SEISAKUSHO K.K., Hiratsuka-shi (JP); YOKOSHIMA & COMPANY, Yuki-gun (JP)

(21) Appl. No.: 10/626,289

(22) Filed: Jul. 24, 2003

(30) Foreign Application Priority Data
Jul. 24, 2002 (JP) 2002-214780

(51) Int. Cl. F16L 55/18

(52) U.S. Cl. 138/97; 29/402.01

(57) ABSTRACT

A method of repairing a flow passage is provided that allows prevention of deformation of a tubular assembly after hardening of grout material, to maintain the tubular assembly in a desired cylindrical shape. The method comprises the steps of forming a tubular assembly in a pipe, the tubular assembly having an outer diameter smaller than an inner diameter of the pipe; filling a grout material in a clearance between the tubular assembly and the inner wall of the pipe; disposing a tubular expansible and contractile pressure bag within the clearance between the tubular assembly and the inner wall of the pipe in a longitudinal direction of the pipe; filling the pressure bag with a fluid to expand the pressure bag; and supporting the tubular assembly with the expanded pressure bag. With the foregoing process of the present invention, slight deformation of the tubular assembly due to the pressure of the grout material can be absorbed through elastic deformation of the pressure bag to prevent partial deformation of the hardened tubular assembly, thereby maintaining the overall tubular assembly in the desired cylindrical shape.

### BACKGROUND OF THE INVENTION

1. Field of the Invention

The present invention relates to a method of repairing a dilapidated flow passage.

2. Description of the Related Art

When an underground pipe, such as a pipeline or passageway, becomes defective or too old to perform properly, the pipe can be repaired and rehabilitated without digging the earth to expose the pipe, and without disassembling the sections of the pipe. This non-digging method of repairing an underground pipe has been known and practiced commonly in the field of civil engineering.

Specifically, the pipe lining method utilizes a tubular pipe liner bag made of a resin-absorbent material impregnated with a hardenable resin, and having the outer surface covered with a highly air-tight plastic film. The tubular pipe liner bag is inserted into a pipe to be repaired by means of a pressurized fluid such that the pipe liner bag is turned inside out as it proceeds deeper in the pipe. Hereinafter, this manner of insertion shall be called “everting”. When the entire length of the tubular liner bag is everted (i.e., turned inside out) into the pipe, the everted tubular liner is pressed against the inner wall of the pipe by a pressurized fluid, and the tubular flexible liner is hardened as the hardenable resin impregnated in the liner is heated, which is effected by heating the fluid filled in the tubular liner bag. It is thus possible to form a plastic pipe within the pipe to repair the same.

In the pipe lining method as described above, a service fluid such as sewage must be temporarily stopped or bypassed at the portion of the pipe subjected to the repair in order to prevent the service fluid from flowing therethrough.

However, a large amount of service fluid must be bypassed, particularly, in the event of repairing a pipe having a large diameter, the repair operation encounters difficulties in installing large scale facilities for bypassing the service fluid.

To solve this problem, the applicants have proposed a method of repairing a pipe while a service fluid is passed therethrough. Referring to FIG. 18, this method involves forming a small tubular assembly 115 having an outer diameter smaller than the inner diameter of a pipe 120 within the pipe 120, filling a grout material 135 in a clearance S between the tubular assembly 115 and pipe 120, and hardening the grout material 135.

In the method illustrated in FIG. 18, a block body 101 divided into a plurality (five in the example illustrated in FIG. 18) of sections are assembled together within the pipe 120 to form the tubular assembly 115. Then, the grout material 135 is injected into the clearance S between the tubular assembly 115 and pipe 120 from a grout hose 134 which is connected to a hole 101e of the tubular assembly 115.

When the grout material 135 is filled in the clearance S between the tubular assembly 115 and pipe 120, the tubular assembly 115 rises due to buoyancy to reduce the width of the clearance S on the upper side.

To solve this problem, the tubular assembly 115 is spread by a jack 140 and bars 141 disposed therein to ensure the cylindrical shape of the tubular assembly 115. In addition, a bolt 136 is disposed at the peak of the tubular assembly 115 to adjust the clearance S between the inner wall of the pipe 120 and tubular assembly 115, such that the clearance S is substantially uniform over the entirety.

Also, rotation of a handle 142 causes the jack 140 disposed within the tubular assembly 115 to radially move the upper and lower bars 141 outwardly (indicated by arrows in FIG. 18), and arcuate supporting plates 143 attached to the ends of the respective bars 141 press up and down upon the inner surface of the tubular assembly 115 to radially push open the tubular assembly 115 outwardly so that the tubular assembly 115 stays in a cylindrical shape.

Actually, however, it has been demonstrated that the tubular assembly 115 is deformed into a substantially heart shape, as indicated by a one-dot chain line in FIG. 18, by the pressure of the grout material 135 which is filled in the clearance S (the one-dot chain line in FIG. 18 indicates the deformation of the center line of the tubular assembly 115), and therefore there is failure to maintain the tubular assembly 115 in the desired cylindrical shape after hardening.

Also, because the grout material 135 is injected into the clearance S from a position which is offset to the left or right of a vertical plane that passes the center of the pipe 120, the grout material 135 is not uniformly injected into the clearance S, which constitutes an additional cause of deformation of the tubular assembly 115.

In addition, in the structure illustrated in FIG. 18, because the jack 140 is disposed at the center of the tubular assembly 115 with the bars 141 extending up and down from the jack 140, the operator is prevented from moving within the tubular assembly 115 during the operation, thus degrading workability.

### OBJECTS AND SUMMARY OF THE INVENTION

It is therefore an object of the present invention to provide a method of repairing a flow passage which is capable of preventing deformation of a tubular assembly after hardening in order to maintain the tubular assembly in a desired cylindrical shape.

It is another object of the present invention to provide a method of repairing a flow passage which is capable of permitting an operator to move within a tubular assembly formed within the flow passage to improve workability.

To achieve the above objects, the present invention provides a method of repairing a pipeline which comprises the steps of forming a tubular assembly in a pipe, wherein the tubular assembly has an outer diameter smaller than an inner diameter of the pipe; filling a grout material in a clearance between the tubular assembly and the inner wall of the pipe; disposing a tubular expansible and contractile pressure bag within the clearance between the tubular assembly and the inner wall of the pipe in a longitudinal direction of the pipe; filling the pressure bag with a fluid to expand the pressure bag; and supporting the tubular assembly with the expanded pressure bag.

Preferably, in the method described above, the step of disposing a tubular expansible and contractile pressure bag in the longitudinal direction of the pipe may include attaching the pressure bag to hook-and-loop fasteners adhered on the inner wall of the pipe. The step of filling the pressure bag with a fluid may include filling the pressure bag with compressed water at a predetermined pressure.

The method may further comprise the steps of discharging the fluid filled in the pressure bag after the grout material filled in the clearance between the tubular assembly and the inner wall of the pipe is hardened; and filling the pressure bag with a grout material and hardening the grout material.

The method may further comprises the step of introducing a triangular support into the tubular assembly for supporting the tubular assembly at three points on the inner surface of the tubular assembly by means of such support. The tubular assembly may be supported at a peak, a left-hand side location, and a right-hand side location on the inner surface thereof.

In the method described above, the step of filling a grout material includes alternately injecting a portion of the grout material and stopping the injection until the portion of the grout material is hardened, a plurality of times.

According to the present invention, because the tubular assembly is supported at upper left and right locations by the expanded pressure bag, slight deformation of the tubular assembly due to the pressure of the grout material can be absorbed through elastic deformation of the pressure bag to prevent partial deformation of the hardened tubular assembly, thereby maintaining the overall tubular assembly in the desired cylindrical shape.

Because the pressure bag is attached to the hook-and- loop fasteners adhered on the inner wall of the pipe such that the pressure bag extends in the longitudinal direction of the pipe, the pressure bag can be previously disposed within the pipe with good workability before the tubular assembly is formed within the pipe.

Also, because the pressure bag is filled with compressed water at a predetermined pressure, deformation of the tubular assembly can be effectively prevented, as compared to a pressure bag filled with a highly compressible gas, such as air.

As the grout material filled in the clearance between the tubular assembly and the inner wall of the pipe is hardened, the fluid filled in the pressure bag is discharged before the grout material is filled in the pressure bag and hardened, so that the pressure bag also functions as the grout material.

The triangular support introduced into the tubular assembly functions to support the tubular assembly at the peak, lower left, and lower right locations on the inner surface thereof, thereby preventing deformation of the hardened tubular assembly. In addition, because the operator can pass through the triangular support, the operator can freely move about within the tubular assembly, thereby improving workability.

Because the grout material is injected in parts a plurality of times, the grout material uniformly injected into the overall clearance is gradually hardened from below, thereby further effectively preventing deformation of the tubular assembly.

The above and other objects, advantages and features of the present invention will become more apparent from the following detailed description of embodiments when read in conjunction with the accompanying drawings.

### BRIEF DESCRIPTION OF THE DRAWINGS

FIG. 1 is a side view of a block unit for repairing a pipe according to one embodiment of the present invention;

FIG. 2 is an outer view (seen in a direction indicated by an arrow A in FIG. 1) of the block unit illustrated in FIG. 1;

FIG. 3 is a cross-sectional view of the block unit taken along a line B-B in FIG. 2;

FIG. 4 is a diagram illustrating the block unit when seen in a direction indicated by an arrow C in FIG. 2;

FIG. 5 is a cross-sectional view of the block unit taken along a line D-D in FIG. 4;

FIG. 6 is a cross-sectional view of the block unit taken along a line E-E in FIG. 2;

FIG. 7 is a side view of a cover for use in a repair according to the present invention;

FIG. 8 is a cross-sectional view of the cover taken along a line F-F in FIG. 7;

FIGS. 9 and 10 are cross-sectional views of a pipe for showing a method of repairing a flow passage according to one embodiment of the present invention;

FIG. 11 is a partial perspective view showing how pressure bags are introduced into a pipe;

FIG. 12 is a cross-sectional view of the pipe in which the pressure bags are disposed;

FIGS. 13 and 14 are broken side views showing a method of connecting annular members adjoining in a longitudinal direction;

FIG. 15 is a cross-sectional view taken along a line H-H in FIG. 14;

FIG. 16 is a cross-sectional view of the pipe which has a tubular assembly formed therein;

FIG. 17 is a cross-sectional view of the pressure bag; and

FIG. 18 is a cross-sectional view of a pipe for showing a conventional method of repairing a pipeline.

### DESCRIPTION OF THE PREFERRED EMBODIMENTS

The present invention will hereinafter be described in connection with several preferred embodiments thereof with reference to the accompanying drawings.

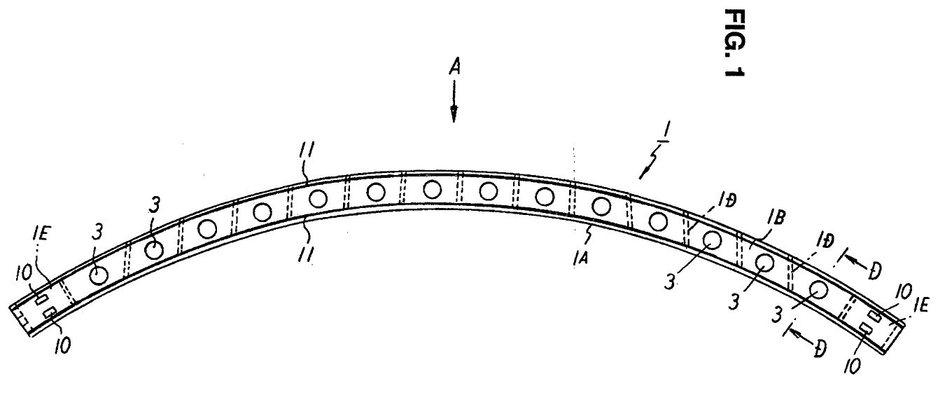

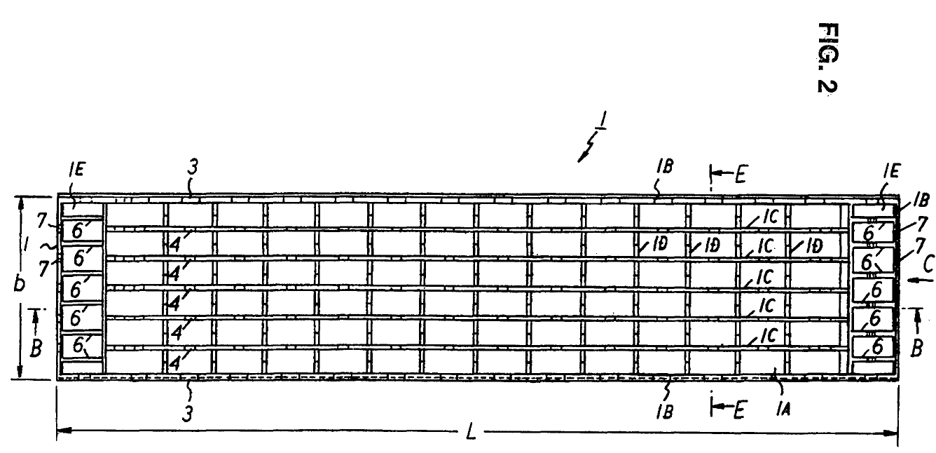

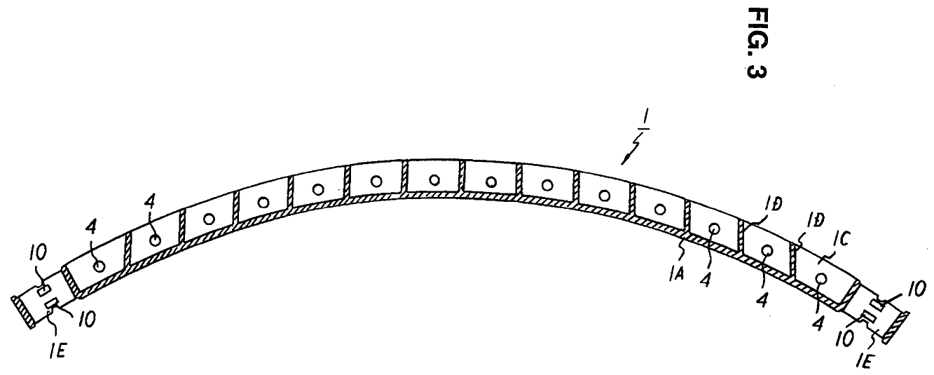

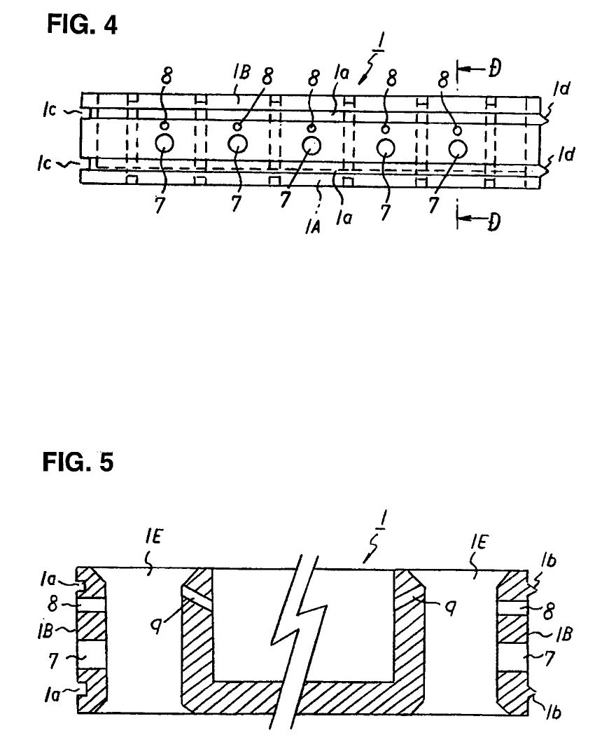

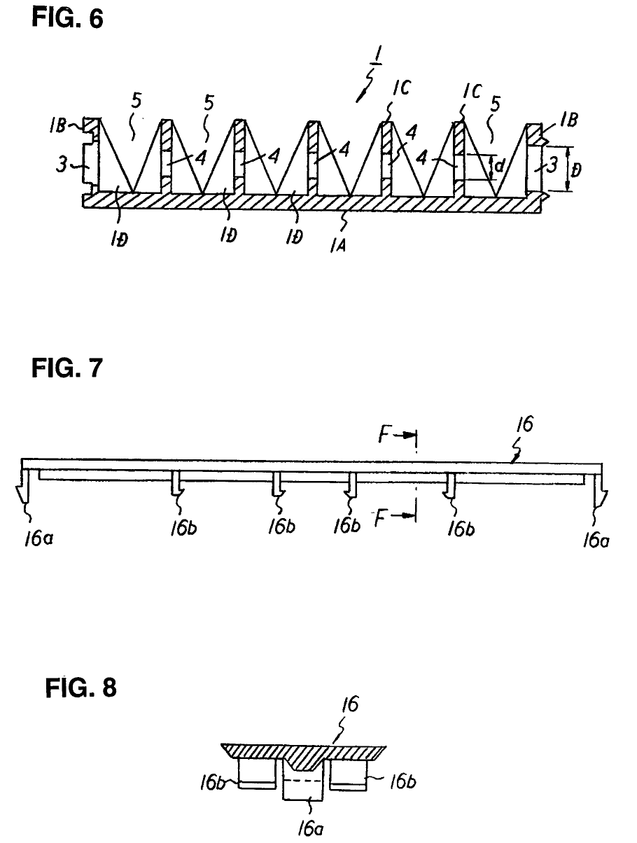

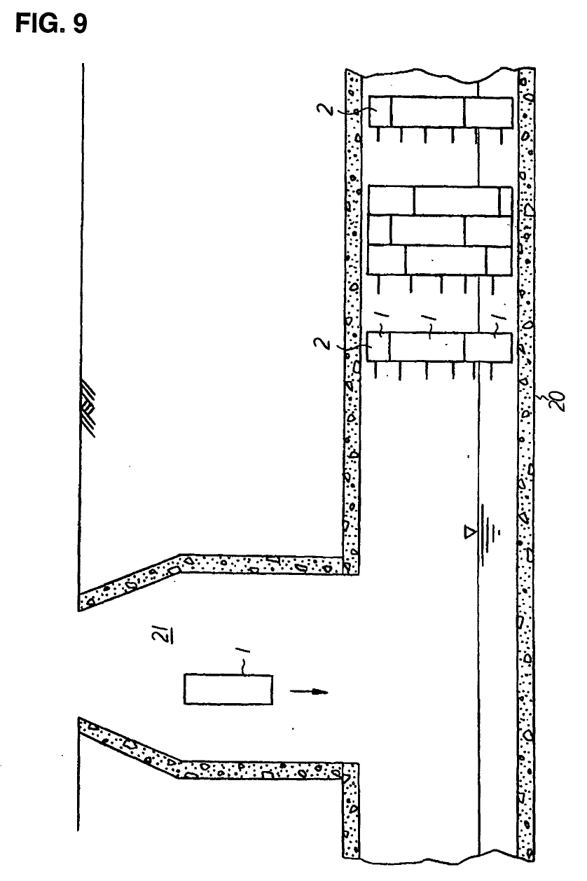

FIG. 1 is a side view of a block unit for repairing a pipe according to one embodiment of the present invention; FIG. 2 is an outer view (seen in a direction indicated by an arrow A in FIG. 1) of the block unit for repairing a pipe according to the embodiment; FIG. 3 is a cross-sectional view taken along a line B-B in FIG. 2; FIG. 4 is a diagram illustrating the block unit when seen in a direction indicated by an arrow C in FIG. 2; FIG. 5 is a cross-sectional view taken along a line D-D in FIG. 4; FIG. 6 is a cross-sectional view taken along a line E-E in FIG. 2; FIG. 7 is a side view of a cover; and FIG. 8 is a cross-sectional view taken along a line F-F in FIG. 7.

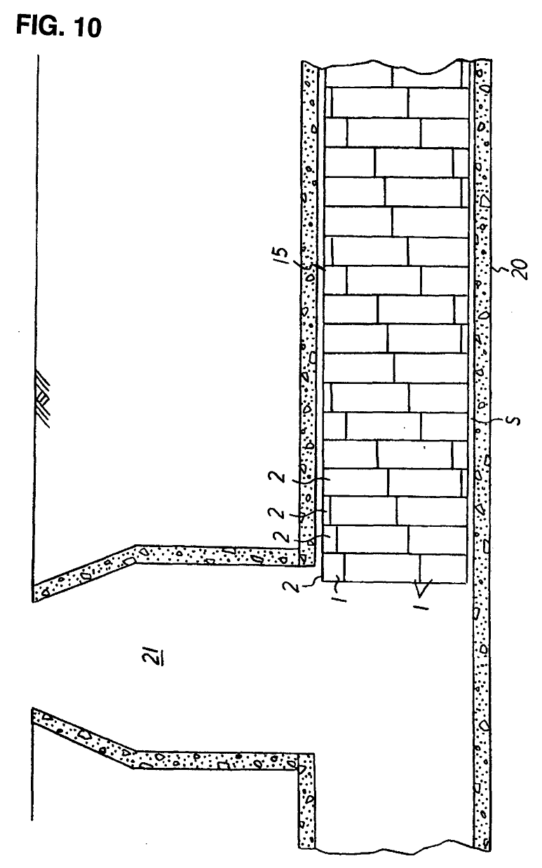

The block unit 1 for repairing a flow passage (hereinafter simply called the “block unit 1”) according to one embodiment of the present invention forms part of a short tube 2 having an outer diameter smaller than the inner diameter of a pipe 20 illustrated in FIGS. 9 and 10 (the short tube 2 is divided into a plurality (five in this embodiment) of pieces). The block unit 1 comprises an arcuate flat inner plate 1A defining an inner surface; an outer plate 1B implanted outwardly along the peripheral edge of the inner plate 1A; a plurality of reinforcing ribs 1C for reinforcing the inner plate 1A and outer plate 1B; a plurality of convex plates 1D for preventing the reinforcing ribs 1C from deforming; and boxes 1E disposed at both circumferential ends of the block unit 1. These components may be integrally formed of a plastic material.

The plastic material forming part of the block unit 1 may be made of transparent plastic such as vinyl chloride, ABS, Duraster Polymer (Tradename) or the like, translucent plastic such as PVC, polyethylene or the like, or opaque plastic such as PVC, polyester, ABS, polyethylene, polypropylene or the like. The block unit 1 is integrally molded by an injection method using such a plastic material to have the weight in a range of 1 kg to 10 kg. The inner plate 1A and outer plate 1B each have a thickness of 1.0 mm to 10.0 mm. A circumferential dimension L is set larger than a width dimension b (longitudinal direction of the pipe 20) (L>b), as can be seen in FIG. 2.

In the block unit 1, a plurality (five in this embodiment) of the reinforcing ribs 1C extending in the circumferential direction (from left to right in FIG. 2) on the inner plate 1A are arranged in parallel at proper intervals in the width direction (vertical direction in FIG. 2, and longitudinal direction of the pipe 20). A plurality (thirteen in this embodiment) of the convex plates 1D, which extend on the inner plate 1A in a direction perpendicular to the respective reinforcing ribs 1C (width direction), are arranged in parallel at proper intervals in the circumferential direction. Thus, the inner plate 1A and outer plate 1B of the block unit 1 are reinforced by the plurality of reinforcing ribs 1C and the plurality of convex plates 1D arranged in a lattice form to increase rigidity.

As illustrated in FIG. 2, in an area defined by the outer plate 1B and the convex plates 1D of the reinforcing ribs 1C, bolt throughholes 3 having larger diameters, and bolt throughholes 4 having a smaller diameters, are formed along a straight line in the width direction (vertical direction in FIG. 2).

Here, as illustrated in FIG. 6, each area surrounded by the reinforcing rib 1C of each convex plate 1D is formed with a space 5 cut in V-shape which has a leading end in contact with the inner plate 1A. Alternatively, as illustrated in FIG. 7, a circular space 6′ in contact with the inner plate 1A may be formed in each area surrounded by the reinforcing rib 1C of each convex plate 1D.

The inner surface and outer surface of the box 1E formed at each peripheral end of the block unit 1 are opened. As illustrated in FIG. 2, the interior of the box 1E is partitioned by a plurality (six in this embodiment) of reinforcing ribs 6 arranged side by side in the width direction. Also, a plurality (five in this embodiment) of bolt throughholes 7 and air vents 8 are formed through the outer plate 1B which defines a peripheral outer end face, as illustrated in FIGS. 4 and 5. Further, as illustrated in FIG. 5, an air vent 9 is formed obliquely in the inner wall of the outer plate 1B. Two rectangular grooves la are formed in one peripheral end face of the outer plate 1B over the entire length thereof, while two protrusions 1b are formed on the other end face over the entire length thereof, as illustrated in FIG. 5.

As illustrated in FIG. 4, two rectangular grooves 1c are formed in one outer end face (outer end face in the longitudinal direction) of the outer plate 1B of the block unit 1, while two protrusions 1d are integrally formed on the other outer end face of the outer plate 1B.

Turning back to FIG. 1, two inner and outer rectangular holes 10 are also formed at both circumferential ends of both outer plates 1B of the block unit 1 (only one outer plate 1B is shown in FIG. 1).

Next, a method of repairing a flow passage using the block unit 1 illustrated in FIGS. 1 to 6 according to one embodiment of the present invention will be described with reference to FIGS. 9 to 17, where the method is applied particularly for repairing a pipe.

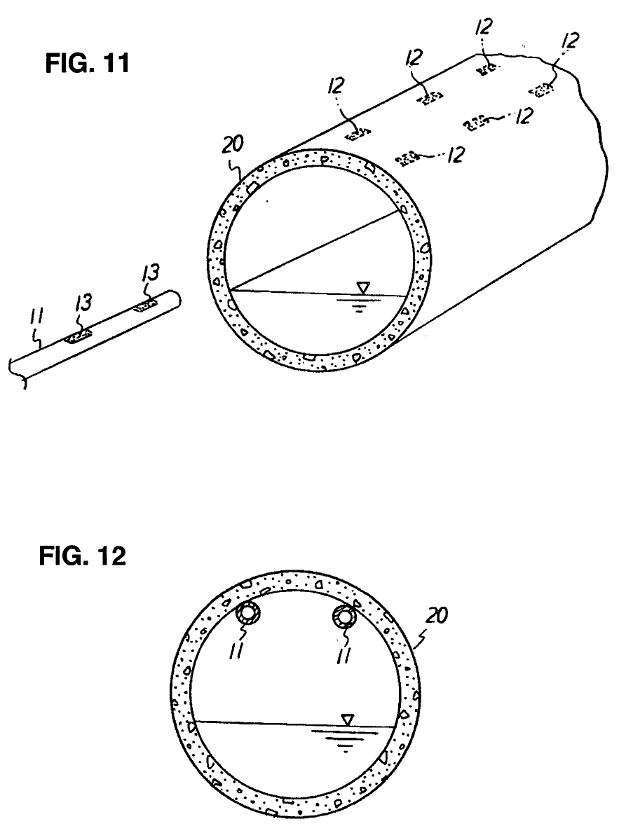

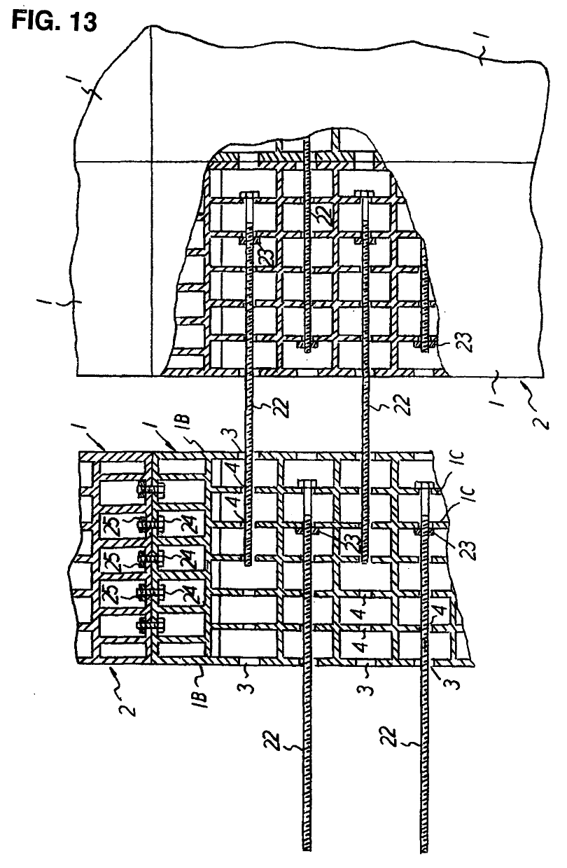

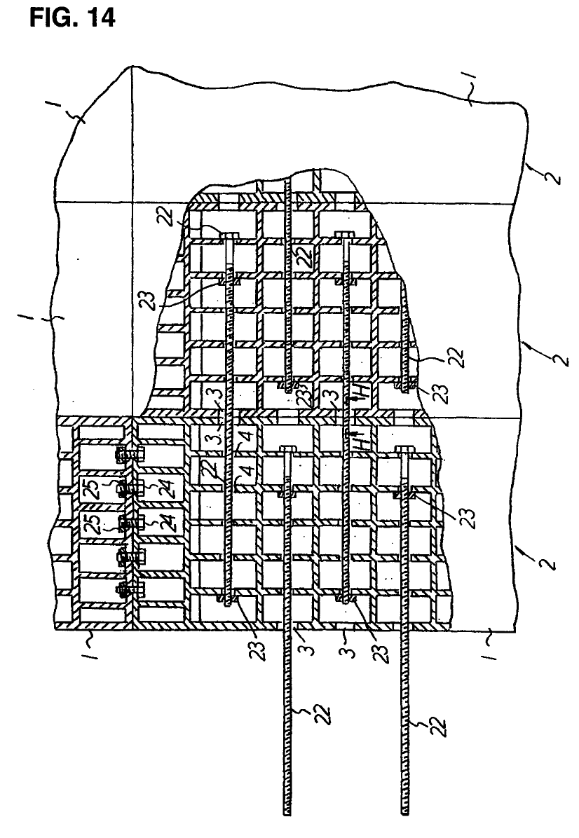

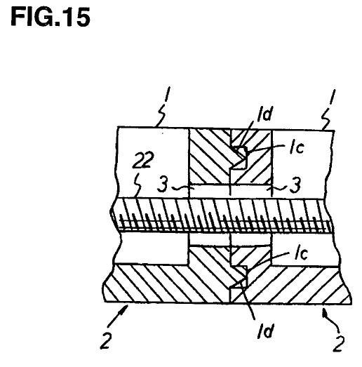

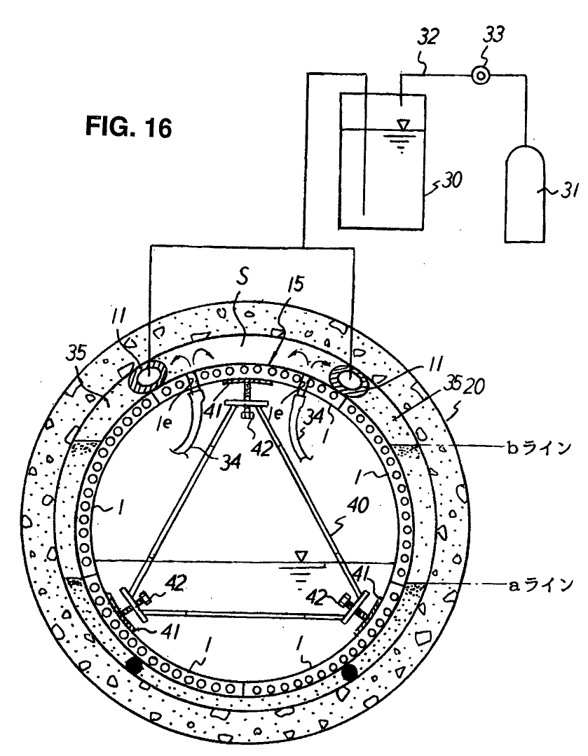

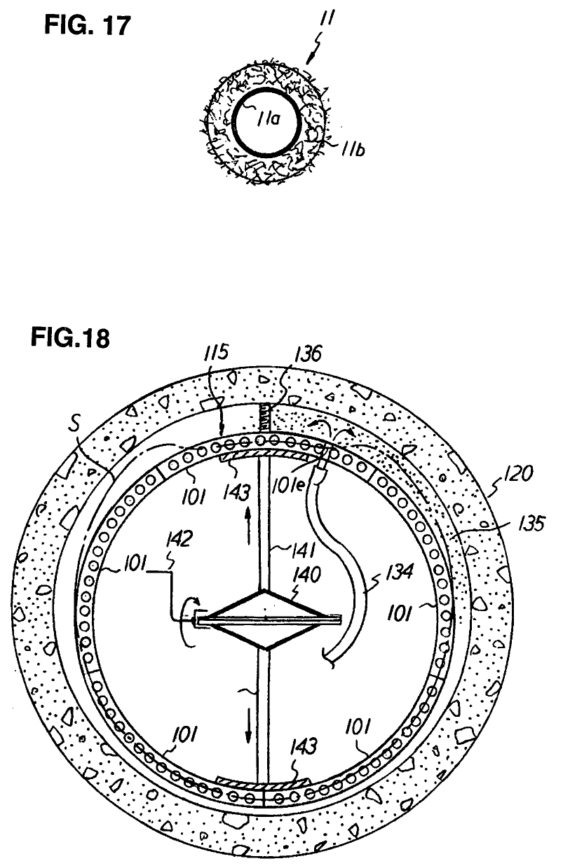

FIGS. 9 and 10 are cross-sectional views of a pipe for showing the method of repairing a flow passage according to one embodiment of the present invention; FIG. 11 is a perspective view illustrating a portion of a pipe for showing how a pressure bag is introduced into the pipe; FIG. 12 is a cross-sectional view of the pipe equipped with the pressure bags; FIGS. 13 and 14 are exploded side views illustrating how to connect annular members adjoining in a longitudinal direction; FIG. 15 is a cross-sectional view taken along a line H-H in FIG. 14; FIG. 16 is a cross-sectional view of the pipe which is formed with a tubular assembly therein; and FIG. 17 is a cross-sectional view of the pressure bag.

Referring first to FIGS. 9 and 10, a pipe 20 such as a sewage pipe embedded substantially horizontally under the ground includes a manhole 21 open to the ground. In the repairing method according to this embodiment, as illustrated in FIG. 12, two expansible and contractile tubular pressure bags 11 are first disposed on the inner wall of a pipe 20 along the longitudinal direction thereof. Specifically, as illustrated in FIG. 11, the pipe 20 is provided with a plurality of hook-and-loop fasteners 12 which are arranged in a left line and a right line at a proper pitch along the longitudinal direction in an upper portion of the inner wall of the pipe 20. Each of the pressure bags 11 is also provided with a plurality of hook-and-loop fasteners 13 on the outer peripheral surface thereof at the same pitch as that of the hook-and-loop fasteners 13 on the pipe 20 in the longitudinal direction.

For disposing the pressure bags 11 within the pipe 20 as described above, the pressure bags 11 are introduced into the pipe 20. Then, the hook-and-loop fasteners 13 attached to the pressure bags 11 are aligned with and joined to the hook-and-loop fasteners 12 fixed on the inner wall of the pipe 20. Further, the joined hook-and-loop fasteners 12, 13 are adhered to each other with an adhesive to dispose the pressure bags 11 in the upper portion of the inner wall of the pipe 20 in the longitudinal direction of the pipe 20 with good workability. It should be noted that the illustration of the pressure bags 11 is omitted in FIGS. 9 and 10.

After the two pressure bags 11 are disposed in the upper portion of the inner wall of the pipe 20, a plurality of annular short tubes 2, each made up of a plurality (five) of adjacent block units 1 joined in the circumferential direction, are joined to each other in the longitudinal direction of the pipe 20 to form a single tubular assembly 15 as illustrated in FIG. 10 in the pipe 20.

The short tube 2 is formed by joining the block units 1 one by one within the pipe 20 in the circumferential direction. The tubular assembly 15 is made by connecting the respective short tubes 2 in the longitudinal direction. These operations can be performed while a service fluid such as sewage is flowing through the pipe 20. In addition, the operations can be performed even when the service fluid stays on the bottom of the pipe 20.

The block units 1 are joined in the circumferential direction in the following manner to form the short tube 2.

First, the block units 1 to be assembled are introduced into the entrance of the pipe 20 from the manhole 21, as illustrated in FIG. 12. Each block unit 1 is small in size because a plurality of block units 1 are assembled into each short tube 2 which forms part of the tubular assembly 15. Therefore, even if the pipe 20 has a large diameter (600 mm or more), the block units 1 for use in a repair of the pipe 20 can be readily introduced thereinto from the manhole 21 and assembled in the short tubes 2.

In the block unit 1 before assembly, the outer opening of the box 1E formed at each circumferential end is covered with a cover 16 illustrated in FIGS. 7 and 8.

The cover 16 is integrally molded from a plastic material, and has engaging pawls 16a integrally formed at both lateral ends, as illustrated in FIG. 7. Also, a total of eight anchor pawls 16b are integrally formed on the lower surface of the cover 16. The cover 16 is overlaid on the box 1E of the block unit 1 to close the outer openings. The engaging pawls 16a on both ends are engaged with the rectangular holes 10 (see FIG. 1) formed in the outer plate 1B of the block unit 1, and then the cover 16 is adhered or welded to cover the outer openings of the boxes 1E of the block unit 1, as described above.

Also, in the block unit 1 before assembly, seven bolts 22 (only two of which are shown in FIG. 13) longer than the length b (see FIG. 2) of the block unit 1 are alternately inserted into the bolt throughholes 3, 4 having different diameters, formed through the outer plate 1B and reinforcing ribs 1C. Each bolt 22 is secured to the block unit 1 with a nut 23 screwed therewith. A threaded portion of the bolt 22 protrudes outwardly from one end face of the block unit 1 as illustrated. Likewise, in each block unit 1 assembled into the short tube 2, the bolts 22 are inserted through the block unit 1 and secured on one end face, with their threaded portions protruding outwardly.

The head of each bolt 22 extends through a bolt throughhole 3 having a large diameter, formed through the outer plate 1B, and in contact with the reinforcing rib 1C. The nuts 23 engaged with the bolts 22 are also in contact with the reinforcing rib 1C. Therefore, the heads of the bolts 22 and nuts 23 will not be exposed to the outside of the block unit 1. The bolts 22 and nuts 23 are made of a metal such as stainless steel, iron or the like or a plastic material such as nylon, polyester or the like. A washer, a cushion material, or the like may be placed at a position at which each bolt 22 is fastened.

Two block bodies 1 adjoining in the circumferential direction are joined to each other in the following manner.

The boxes 1E of two block units 1 adjoining in the circumferential direction are in close contact with each other in the circumferential direction. The plurality of bolt throughholes 7 and air vents 8 formed through the block units 1 are in communication with each other, and the protrusion 1b formed on the end face of one block unit 1 is fitted in the groove 1a formed in the end face of the other block unit 1 to seal the joint of the both block units 1 in the circumferential direction. In this event, an adhesive may be applied on the groove la and protrusion 1b to improve the adhesivity therebetween. The adhesive used herein may be an adhesive based on an epoxy resin or a tetrahydrofuran solvent, or a silicon- acrylic-, urethane-, or butyl rubber-based adhesive.

Because the inner surfaces of both boxes 1E are opened, a bolt 24 is inserted from the opening of one box 1E through the bolt throughhole 7, while a nut 25 is inserted from the opening of the other box 1E and fitted on the bolt 24 (see FIG. 11). This operation is repeated to join two block units 1 adjoining in the circumferential direction to each other.

Then, as the block units 1 adjoining in the circumferential direction are joined to each other in the manner described above as illustrated in FIG. 14, a putty is filled in the boxes 1E of both block units 1, and the respective openings on the inner surfaces are covered with the cover 16 illustrated in FIGS. 7 and 8 in the manner described above. In this event, because the cover 16 is formed with a plurality of anchor pawls 16b, the cover 16 is prevented from coming off by an anchoring effect of the anchor pawls 16 within the putty. The putty used herein for filling in the boxes 1E may be a resin putty such as an epoxy resin, a polyester resin, a silicone resin, or the like, a cement putty, or the like. The box 1E is not necessarily filled with the putty, but may be filled with a grout material after assembly.

As the short tube 2 is formed as described above, a plurality of short tubes 2 are connected to each other in the longitudinal direction of the pipe 20 as illustrated in FIG. 9 to form a single tubular assembly 15, as illustrated in FIG. 10, within the pipe 20. In the following, description will be made on how to connect the short tubes 2 in the longitudinal direction.

Referring to FIG. 13, the bolts 22 protruding from an assembled short tube 2 (short tube 2 adjoining in the longitudinal direction of the pipe 20) are inserted into remaining bolt throughholes 3, 4, through which no bolts have been inserted, of a short tube 2 before assembly, and the short tube 2 before assembly is brought into close contact with the assembled short tube 2. Consequently, as illustrated in FIG. 15, the protrusion 1d on the end face of the short tube 2 before assembly is fitted into the recess 1c formed in the end face of the assembled short tube 2 to align both short tubes 2 as well as seal the joint of both short tubes 22.

Subsequently, a nut 23 fitted on the end of the bolt 22 is fastened with a tool which is introduced from the bolt throughhole 3 having a larger diameter to assemble the short tube 2 before assembly into the assembled short tube 2, as illustrated in FIG. 14. In this event, because the head of the bolt 22 and the nut 23 are not exposed to the outside of the block 1 as described above, the two short tube 2 adjoining in the longitudinal direction of the pipe 20 are connected in close contact.

When the two short tubes 2 adjoining in the longitudinal direction of the pipe 20 are connected to each other as described above, the short tubes 2 are sequentially assembled in the longitudinal direction of the pipe 20 in a similar manner to form a single tubular assembly 15 within the pipe 20.

Because the tubular assembly 15 formed within the pipe 20 has an outer diameter smaller than the inner diameter of the pipe 20, a clearance S (see FIG. 16) is formed between the tubular assembly 15 and pipe 20. The tubular assembly 15 floats up by buoyancy to reduce a upper radial gap of the clearance S above the tubular assembly 15.

To solve this inconvenience, in this embodiment, the pressure bags 11 disposed on the left and right sides above the clearance S within the pipe 20 are filled with compressed water at a predetermined pressure (in the range of 0.05 MPa to 0.5 MPa) to expand the pressure bags 11, as can be seen in FIG. 16, such that the expanded pressure bags 11 support the tubular assembly 15 at upper left and right locations on the outer periphery to prevent the tubular assembly 15 from floating up due to buoyancy, thus making the clearance S substantially uniform over the entirety. Alternatively, the tubular assembly 15 may be prevented from floating up due to-buoyancy by piling up a plurality of gabions on the downstream side of the pipe 20 to intercept service water which is stored within the tubular assembly 15 to prevent the tubular assembly 15 from floating up, making use of the effect of gravity upon the water.

As illustrated in FIG. 17, the pressure bag 11 is made up of a flexible hose 11a and an unwoven fabric 11a such as polypropylene which covers the outer surface of the flexible hose 11a, and is filled with compressed water at a fixed pressure at all times by an apparatus illustrated in FIG. 16.

Referring specifically to FIG. 16, a closed tank 30 contains water in which one end of the pressure bag 11 is immersed. An air hose 32 extends from an air cylinder 31 and is connected to the top of the closed tank 30. An automatic pressure adjusting valve 33 is disposed halfway along the air hose 32.

When a slight leak of compressed water or the like causes the water level in the closed tank 30 to be lower, thereby reducing the internal pressure in the closed tank 30, the automatic pressure adjusting valve 33 is opened to supply the compressed air in the air cylinder 31 into the enclosed tank 30 through the air hose 32, to maintain a constant internal pressure within the closed tank 30 at all times, so that the pressure bag 11 is filled with compressed water at a fixed pressure at all times.

In addition, as illustrated in FIG. 16, a triangular support 40 is disposed within the tubular assembly 15 to support the peak, lower left and lower right points on the inner surface of the tubular assembly 15 at the respective vertexes of the triangular support 40 from the inside of the tubular assembly 15 through arcuate supporting plates 41 and adjusting bolts 42 disposed at the respective vertexes of the support 40.

Here, a supporting force exerted by the support 40 to the tubular assembly 15 can be adjusted by rotating the adjusting bolts 42, to support the tubular assembly 15 at the three points with uniform pressing force.

On the other hand, as illustrated in FIG. 16, holes 1e are formed through an upper portion of the tubular assembly 15 at left-hand side and right-hand side locations. Grout hoses 34 are connected to the respective holes 1e for injecting a grout material 35, such as cement mortar, resin mortar or the like, simultaneously from the two grout hoses 34 into the clearance S between the tubular assembly 15 and the inner wall of the pipe 20.

Here, in this embodiment, the grout material 35 is injected in parts a plurality of times. Specifically, the grout material 35 is injected three times. At the first injection of the grout material 35, injection is stopped at the time the grout material 35 is filled up to a line a indicated in FIG. 16. After the injected grout material 35 is hardened, the injection of the grout material 35 is resumed, and again stopped at the time the grout material 35 is filled up to a line b indicated in FIG. 16. Then, after the grout material 35 filled at the second time is hardened, the grout material 35 is finally filled into the remaining clearance S and hardened.

The cement mortar may be mixed with emulsion for adhesion in order to increase the adhesivity, or may be mixed with a breathing inhibitor in order to prevent breathing. The resin mortar in turn may be mainly composed of an epoxy resin, a polyester resin and the like.

After the grout material 35, which has been filled into the clearance S formed between the tubular assembly 15 and pipe 20, is hardened, the compressed water filled in the pressure bags 11 is discharged before the grout material 35 is filled in the pressure bags 11 and hardened, wherein the tubular assembly 15 is integrated with the pipe 30 by the grout material 35, so that the inner wall of the pipe 20 is lined and thus repaired by the tubular assembly 15.

In the foregoing operation, while the grout material 35 is being injected and hardened, the tubular assembly 15 is supported by the support 40 at three points on the inner surface (peak, lower left and lower right points) from the inside, and is also supported by the two pressure bags 11 at the left-hand side and right-hand side locations in the upper portion of the outer surface thereof from the outside, as illustrated in FIG. 16. Thus, the tubular assembly 15 is less prone to deformation even if pressure is applied by the grout material 35, and maintains the desired cylindrical shape.

Particularly, in this embodiment, because the tubular assembly 15 is supported at the upper left-hand side and right-hand side locations by the expanded pressure bags 11, slight deformation of the tubular assembly 15 due to the pressure of the grout material 35 can be absorbed through elastic deformation of the pressure bags 11 to prevent partial deformation of the hardened tubular assembly 15, thereby maintaining the overall tubular assembly 15 in the desired cylindrical shape. In addition, because the pressure bags 11 are filled with compressed water at a predetermined pressure, deformation of the tubular assembly 15 can be effectively prevented, as compared to a pressure bags 11 filled with a highly compressible gas, such as air.

Also, in this embodiment, because the grout material 35 is injected into the clearance S between the tubular assembly 15 and the inner wall of the pipe 20 simultaneously from the two holes 1e formed at upper left-hand side and right-hand side locations of the tubular assembly 15, the grout material 35 is uniformly injected into the clearance S from the left and right holes 1e, thereby preventing deformation of the tubular assembly 15. In addition, because the grout material 35 is injected into the overall clearance S in parts a plurality of times, the grout material S uniformly injected into the overall clearance S is gradually hardened from below, thereby further effectively preventing deformation of the tubular assembly 15.

Further, in this embodiment, the triangular support 40 is introduced into the tubular assembly 15 for supporting the tubular assembly 15 at three points, i.e., the peak, lower left and lower right points on the inner surface, so that deformation of the hardened tubular assembly 15 is prevented by the support 40. In addition, because the operator can pass through the triangular support 40, the operator can freely move about within the tubular assembly 15, thereby improving workability.

Moreover, in this embodiment, after the grout material 35 filled in the clearance S between the tubular assembly 15 and the inner wall of the pipe 20 is hardened, the compressed water filled in the pressure bags 11 is discharged before the grout material 35 is filled in the pressure bags 11 and hardened, so that the pressure bags 11 also function as the grout material.

While the foregoing description has been made on an application of the present invention to a method of assembling a plurality of block units within a pipe to form a tubular assembly within the pipe, it goes without saying that the present invention can be applied as well to a method of everting a pipe liner bag impregnated with a hardenable resin into a pipe, and hardening the hardenable resin to form a cylindrical pipe (plastic pipe) within the pipe.

As will be apparent from the foregoing description, according to the present invention, because the tubular assembly is supported at the upper left and right locations by the expanded pressure bags, slight deformation of the tubular assembly due to the pressure of the injected grout material can be absorbed through elastic deformation of the pressure bags to prevent partial deformation of the hardened tubular assembly, thereby maintaining the overall tubular assembly in the desired cylindrical shape.

Because the pressure bags are attached to the hook-and-loop fasteners adhered on the inner wall of the pipe such that the pressure bags extend in the longitudinal direction of the pipe, the pressure bag can be previously disposed within the pipe with good workability before the tubular assembly is formed within the pipe.

Also, because each pressure bag is filled with compressed water at a predetermined pressure, deformation of the tubular assembly can be effectively prevented, as compared to a pressure bag filled with a highly compressible gas, such as air.

As the grout material filled in the clearance between the tubular assembly and the inner wall of the pipe is hardened, the fluid filled in each pressure bag is discharged before the grout material is filled in the pressure bag and hardened, so that the pressure bag also functions as the grout material.

The triangular support introduced into the tubular assembly functions to support the tubular assembly at the peak, lower left and lower right locations on the inner surface thereof, thereby preventing deformation of the hardened tubular assembly. In addition, because the operator can pass through the triangular support, the operator can freely move about within the tubular assembly, thereby improving workability.

Because the grout material is injected into the clearance in parts a plurality of times, the grout material uniformly injected into the overall clearance is gradually hardened from below, thereby further effectively preventing deformation of the tubular assembly.

While the present invention has been described in connection with its preferred embodiments, it is to be understood that various modifications will occur to those skilled in the art without departing from the spirit of the invention. The scope of the present invention is therefore to be determined solely by the appended claims.

What is claimed is:

1. A method of repairing a pipeline comprising the steps of:
forming a tubular assembly in a pipe, said tubular assembly having an outer diameter smaller than an inner diameter of said pipe;
filling a grout material in a clearance between said tubular assembly and an inner wall of said pipe;
disposing a tubular expansible and contractile pressure bag within the clearance between said tubular assembly and the inner wall of said pipe in a longitudinal direction of said pipe;
filling said pressure bag with a fluid to expand said pressure bag; and
supporting said tubular assembly by said expanded pressure bag.

2. A method according to claim 1, wherein said step of disposing a tubular expansible and contractile pressure bag in the longitudinal direction of said pipe includes attaching said pressure bag to hook-and-loop fasteners adhered on the inner wall of said pipe.

3. A method according to claim 1, wherein said step of filling said pressure bag with a fluid includes filling said pressure bag with compressed water at a predetermined pressure.

4. A method according to claim 2, wherein said step of filling said pressure bag with a fluid includes filling said pressure bag with compressed water at a predetermined pressure.

5. A method according to claim 1, further comprising the steps of:
discharging the fluid filled in said pressure bag after the grout material filled in the clearance between said tubular assembly and the inner wall of said pipe is hardened; and
filling said pressure bag with a grout material and hardening the grout material.

6. A method according to claim 2, further comprising the steps of:
discharging the fluid filled in said pressure bag after the grout material filled in the clearance between said tubular assembly and the inner wall of said pipe is hardened; and
filling said pressure bag with a grout material and hardening the grout material.

7. A method according to claim 3, further comprising the steps of:
discharging the fluid filled in said pressure bag after the grout material filled in the clearance between said tubular assembly and the inner wall of said pipe is hardened; and
filling said pressure bag with a grout material and hardening the grout material.

8. A method according to claim 4, further comprising the steps of:
discharging the fluid filled in said pressure bag after the grout material filled in the clearance between said tubular assembly and the inner wall of said pipe is hardened; and
filling said pressure bag with a grout material and hardening the grout material.

9. A method according to claim 1, further comprising the step of:
introducing a triangular support into said tubular assembly for supporting said tubular assembly at three points on an inner surface of said tubular assembly by said triangular support.

10. A method according to claim 5, wherein said tubular assembly is supported at a peak, a left-hand side location, and a right-hand side location on the inner surface thereof.

11. A method according to claim 1, wherein said step of filling a grout material includes alternately injecting a portion of the grout material and stopping the injection until the portion of the grout material is hardened a plurality of times.
